(19) United States
(12) Patent Application Publication
(10) Pub. No.: US 2010/0085280 A1
(43) Pub. Date: Apr. 8, 2010

(54) Display system and method therefor

(76) Inventors: David K. Lambert, Sterling Heights, MI (US); Ivan Roy Brouwer, Swartz Creek, MI (US)

Correspondence Address: DELPHI TECHNOLOGIES, INC;LEGAL STAFF - M/C 483-400-402, 5725 DELPHI DRIVE, PO BOX 5052, TROY, MI, 48007, US

(21) Appl. No.: 12/290,559

(22) Filed: Oct. 31, 2008

Related U.S. Application Data
(60) Provisional application No. 61/102,498, filed on Oct. 3, 2008.

(51) Int. Cl. G09G 3/30

(52) U.S. Cl. 345/76

(57) ABSTRACT

A display system and method thereof are provided, wherein the system includes a display device configured to produce a display and a controller in communication with the display device. The display device includes a first portion and a second portion. The controller updates the first portion of the display device at a higher rate than the second portion of the display device.

### CROSS REFERENCE TO RELATED APPLICATION

This application claims priority under 35 U.S.C. §119(e) to U.S. Provisional Patent Application No. 61/102,498, filed on Oct. 3, 2008, by David K. Lambert et al., the entire disclosure of which is hereby incorporated herein by reference.

### TECHNICAL FIELD

The present invention generally relates to a display system, and more particularly, to a display system including a passive matrix organic light emitting diode display device.

### BACKGROUND OF THE DISCLOSURE

Generally, displays used with vehicles, such as an instrument panel, include mechanical gauges that are operably connected to other devices of the vehicle, so that an occupant of the vehicle can monitor operating conditions of the vehicle. Examples of such gauges are a speedometer, an odometer, a gas gauge, and an engine temperature gauge. Typically, the types of gauges utilize a needle or pointer that moves in order to point to a numerical value to indicate the operating condition of the vehicle. Oftentimes, gauges, such as a speedometer gauge, include a needle, wherein it is desirable for the needle to smoothly move at a higher rate (i.e., to indicate that the vehicle is accelerating or decelerating) than compared to other needles, such as the speed of movement of the needle of the temperature gauge or gas gauge.

Generally, a video display can be used to display an image, which can be a stationary image or a series of images that gives the appearance of a moving object. Displays that are utilized to display a series of images typically utilize a sufficient amount of processing or computational capability to continuously update the display with a new image to simulate movement of an object.

### SUMMARY OF THE INVENTION

According to one aspect of the present invention, a display system includes a display device configured to produce a display, and a controller in communication with the display device. The display device includes a first portion and a second portion. The controller updates the first portion of the display device at a higher rate than the second portion of the display device.

According to another aspect of the present invention, a display system includes a passive matrix organic light emitting diode (PMOLED) display device configured to produce a display, and a controller in communication with the PMOLED display device. The PMOLED display device includes a first portion and a second portion. The controller updates the first portion of the PMOLED display device at approximately one hundred twenty times per second, and the controller updates a second portion of the PMOLED display device at approximately sixty times per second.

According to yet another aspect of the present invention, a method of displaying an image includes the steps of providing a frame interval, wherein substantially all pixels of a display are updated during the frame interval, and updating a first portion of the display during a first sub-interval of the frame interval. The method of displaying an image further includes the steps of updating a second portion of the display during a second sub-interval of the frame interval, updating the first portion of the display during a third sub-interval of the frame interval, and updating a third portion of the display during a fourth sub-interval of the frame interval.

### BRIEF DESCRIPTION OF THE DRAWINGS

The present invention will now be described, by way of example, with reference to the accompanying drawings, in which:

FIG. 1 is a block diagram illustrating a display system including a passive matrix organic light emitting diode display device, in accordance with one embodiment of the present invention;

FIG. 2 is a timing diagram illustrating time sub-intervals, in accordance with one embodiment of the present invention;

FIG. 3 is an environmental view illustrating a display system used with an instrument panel in a vehicle, in accordance with one embodiment of the present invention;

FIG. 4 is an environmental view illustrating a display system used with an instrument panel in a vehicle, in accordance with one embodiment of the present invention;

FIG. 5 is an environmental view illustrating a display system used with an instrument panel in a vehicle, in accordance with one embodiment of the present invention;

FIG. 6 is an environmental view illustrating a display system used with an instrument panel in a vehicle, in accordance with one embodiment of the present invention; and

FIG. 7 is a flow chart illustrating a method of displaying an image, in accordance with one embodiment of the present invention.

### DESCRIPTION OF PREFERRED EMBODIMENTS

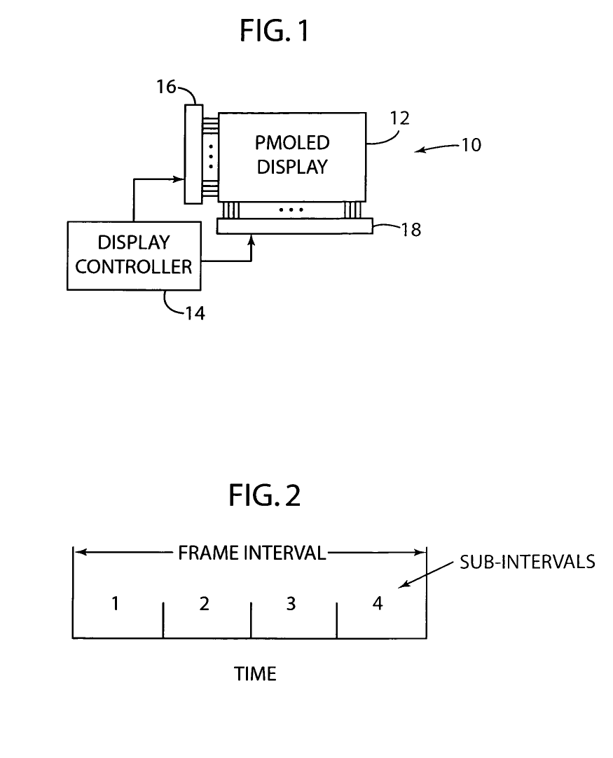

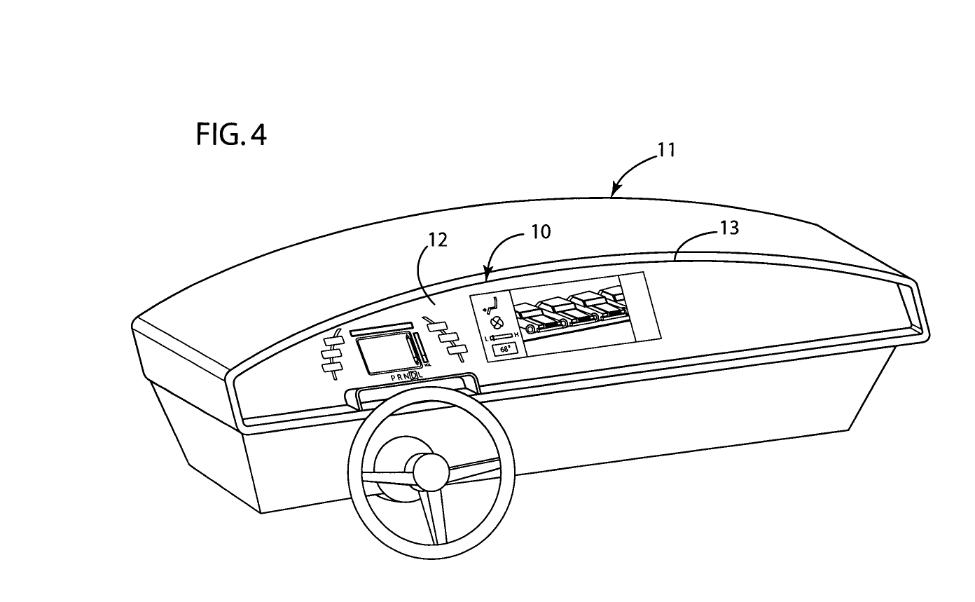

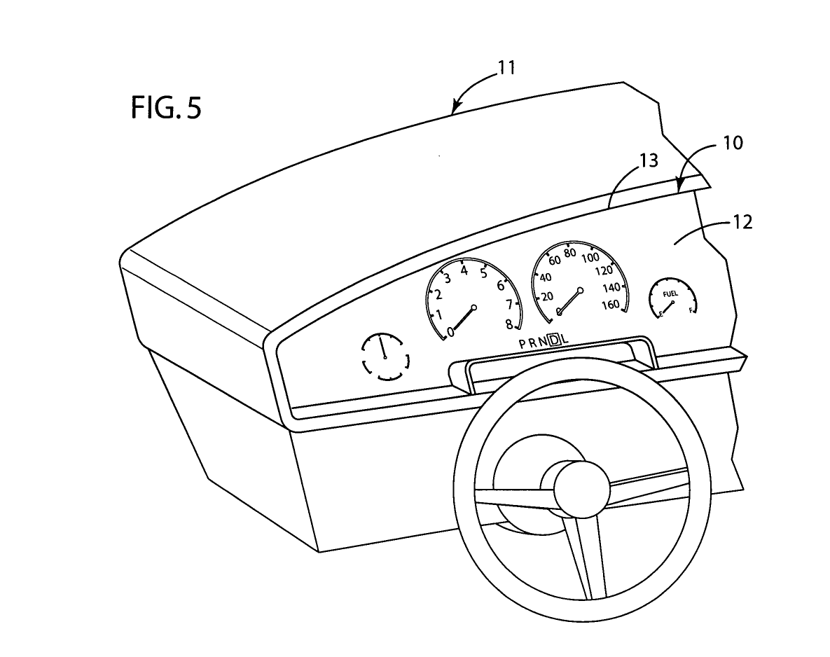

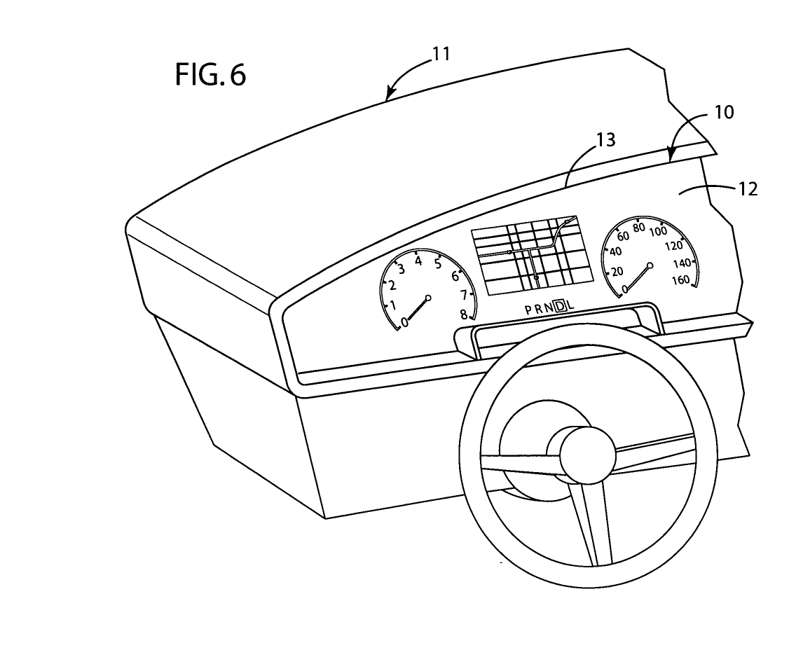

In reference to FIGS. 1 and 3-6, a display system is generally shown at reference identifier 10. The display system 10 includes at least one display device 12, wherein the display device 12 can be an active matrix organic light emitting diode (AMOLED) display, a passive matrix organic light emitting diode (PMOLED) display, or the like. According to one embodiment, the display system 10 can be used in a vehicle generally indicated at reference identifier 11 (FIGS. 3-6), such that the display device forms at least a portion of an instrument panel 13 of the vehicle 11, as described herein. In such an embodiment, the display system 10 can be utilized to replace electromechanical devices that can otherwise be utilized on vehicle instrument panels.

The display system 10 can further include a controller, such as a display controller 14, a row selector 16, and column drivers 18. According to one embodiment, when the display device 12 is an AMOLED display, each pixel of the display device 12 can have associated circuit on a back-plane to control pixel electrical current. According to an alternate embodiment, when the display device 12 is a PMOLED display, the pixel electrical current can be controlled by a separate driver chip. Typically, when driving a PMOLED display, the driver chip cycles through the rows, one-by-one, and controls brightness of each pixel in that row by the length of time a constant electrical current pulse is delivered. However, there can be a limit on the number of rows that can be driven. In one exemplary embodiment, the maximum number of pixels that can be driven can be one hundred twenty eight by one hundred sixty (120×160) full-colored pixels with connections to one vertical and horizontal edge of the display device 12, wherein the number of rows can be substantially doubled by connecting columns at a top and bottom of the display device 12.

According to an alternate embodiment, the PMOLED display can be driven, such that multiple rows are driven simultaneously with the same column electrical current (e.g., multi-line addressing (MLA)). By way of explanation and not limitation, the PMOLED display can control two hundred forty by four hundred thirty-two (240×432) full-colored pixels. In such an embodiment, the driver chip can address either two (2) rows, one next to the other, or one (1) row, such that it is optimized to display video.

According to one embodiment, a PMOLED display is utilized in the instrument panel 13 in vehicle 11, wherein in order for imaged gauge needles to appear as electromechanical gauge needles (e.g., appear to have smooth movement), the gauge needle portion of the display device 12 is updated approximately one hundred twenty times per second. Additionally, the PMOLED display can be a flat-panel display. Typically, a PMOLED driver selectively writes to a first portion of the display device 12 (e.g., the portion of the display device 12 that is imaging the gauge needles), wherein only the first portion of the display device 12 is updated at a higher rate. Thus, the display device 12 can have more pixels and utilize less computational power (e.g., a smaller or less powerful processor), than if the entire display were updated at the higher rate. Moreover, less memory bandwidth is needed. This can result is reducing a manufacturing cost of the display, while allowing the images of analog or electromechanical needles appear to move smoothly. It should be appreciated by those skilled in the art that the description herein describes an image of a gauge needle for purposes of explanation and not limitation, such that the portion of the image that is updated at the higher rate can display any image that it is desirable for the image to appear to be moving fluidly or smoothly, as a similar mechanical device might function.

Typically, to obtain the desired perceived brightness of a moving pointer, updated at a higher rate than other portions of the display, the update rate needs to be taken into account. For example, if the image is updated twice per frame interval, the time duration the pixel is illuminated can be divided by a factor of two (2) to maintain the same perceived brightness. Thus, the first portion of the image is updated at a rate of approximately two times the update rate of the second portion of the image, according to one embodiment. Alternatively, the electrical current supplied to the pixels of the image can be divided by the appropriate amount, or a combination of reduced time duration and decreased electrical current can be used.

To obtain the perception of smooth pointer movement, the tip of the pointer does not skip pixels, according to one embodiment. A fully updated graphics buffer can be available before each image of the pointer is written. Data in the graphics buffer is typically not changed while the image of the pointer is being written. Thus, graphics processing can be completed faster than the update time of the pointer image. In one embodiment, the display update is synchronized with the graphics processing. If the graphics processing is unsynchronized from the display update, the computational update rate typically needs to be at least twice the update rate of the image. According to one embodiment, a computational update rate of five (5) times the update rate of the image can be used. Even with unsynchronized graphics processing that meets the speed requirement, to obtain the perception of smooth pointer movement, the graphics buffer typically does not change while the image of the pointer is being written.

For purposes of explanation and not limitation, in operation, a frame interval is a time interval within which substantially all of the “on” pixels in the display device 12 are addressed. Typically the frame interval is a time period that does not result in a flicker that can be perceived by the human eye. According to one embodiment, the frame interval for the PMOLED display is approximately one-sixtieth of a second ( 1/60 s), and the frame interval for the PMOLED display when displaying an image of a gauge needle can be approximately one-hundred twentieth of a second ( 1/120 s), such that movement of the gauge needle appears smooth. The PMOLED driver typically cycles through substantially all of the rows once each frame interval.

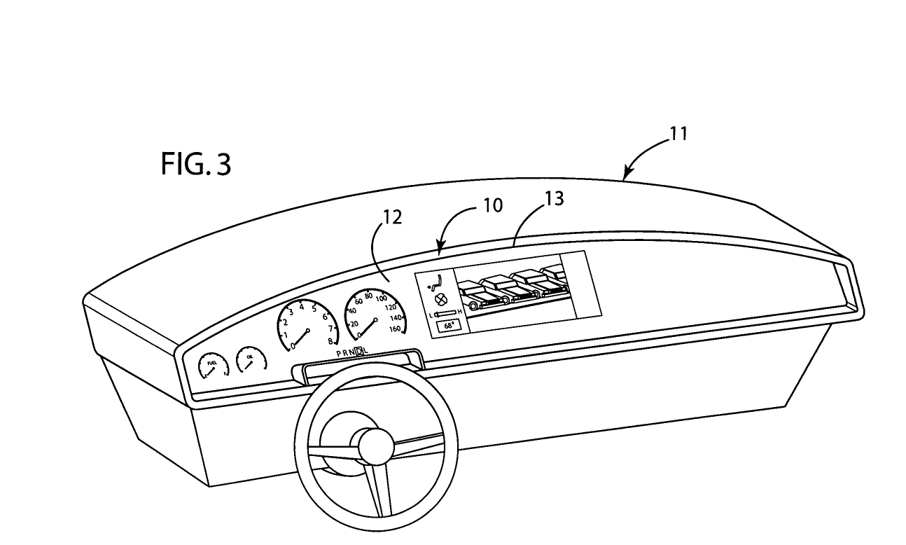

With regards to FIGS. 1 and 2, according to one embodiment, the frame interval is divided into at least four (4) sub-intervals (FIG. 2). During each sub-interval, an algorithm can be used to write information on the display device 12. By way of explanation and not limitation, one type of information that can be written to the display device 12 is an image of a gauge needle. Typically, an image of a moving gauge needle is displayed a plurality of times during a frame interval, such as, but not limited to, during at least two sub-intervals, wherein an apparent gauge needle position on the display device 12 is in correspondence to an indicated quantity as a function of time.

It should be appreciated by those skilled in the art that multiple gauge needles can be displayed, other moving images can be displayed, the like, or a combination thereof. Additionally or alternatively, information that can be displayed in the remaining sub-intervals can include text information, icon information, graphical outline information, background color, background fixed images, live video images, other information that can be displayed by a computer on a conventional flat panel display, the like, or a combination thereof.

As to FIG. 1, the display system 10 can have the PMOLED display device 12 and a cross-matrix that includes the row selector 16 and the column drivers 18, or row and column conductors, to select individual OLED pixels, column electrical current control circuits, row selector circuits, the display controller 14, the like, or a combination thereof, according to one embodiment. Typically, the display controller 14 selects the rows of the display device 12 that are active, and an electrical current that is flowing or propagating into each column.

In regards to FIG. 2, the frame interval is divided into sub-intervals, wherein as illustrated in FIG. 2, two sub-intervals (e.g., sub-interval 1 and sub-interval 3) are chosen so that substantially all the pixels needed to display an image of a gauge needle (e.g., a first portion of the display device 12) can be addressed or updated in sub-interval 1 and sub-interval 3. Thus, when frames are shown in succession, sub-interval 1 and sub-interval 3 occur with approximately equally spaced intervals between them.

In operation, according to one embodiment, during sub-interval 1, the image of the gauge needle on the display device 12 is written by using MLA to step through substantially all the rows where gauge needle intensity is above a threshold value, such as, but not limited to, a non-zero value, and address the columns with a suitable electrical current. During sub-interval 2, the instrument panel 13 or cluster image, except for the portion of the image that displays the gauge needle, is written to the display device 12 rows corresponding to a portion of the display device 12, such as, but not limited to, a top portion of the display device 12. The MLA can be used to write the display rows.

During sub-interval 3, the gauge needle images can be written by using MLA to step through substantially all the rows where gauge needle intensity is above a threshold value, such as, but not limited to, a non-zero value, and address the corresponding columns with the appropriate electrical current. Thus, sub-interval 3 can be substantially similar to sub-interval 1. During sub-interval 4, the instrument panel 13 or cluster image, except for the portion of the image that displays the gauge needle, is written to the display rows corresponding to a portion of the display device 12, such as, but not limited to, a bottom portion of the display device 12, wherein the MLA can be used to write the display rows. It should be appreciated by those skilled in the art that the process or steps performed during sub-intervals 1-4 are for exemplary purposes only, and the steps can be performed at during different sub-intervals. According to one embodiment, the sub-intervals are of approximately an equal time period, such that the first portion of the display or image is updated at a rate of approximately twice the second portion of the display or image.

According to an alternate embodiment, during sub-interval 2, text is written with a suitable algorithm to display text. Additionally or alternatively, during sub-interval 4, video information is written to a portion of the display with a suitable algorithm to display video.

An image of a gauge needle can be computed “on the fly” by a suitable algorithm, and be sent directly to the display device 12, according to one embodiment. Alternatively, an image of a gauge needle can be created in a section of memory and then transferred from the memory to the display device 12. According to yet another embodiment, a portion of the memory describes respective graphic layers, and the individual graphic layers are written to the OLED during individual sub-intervals.

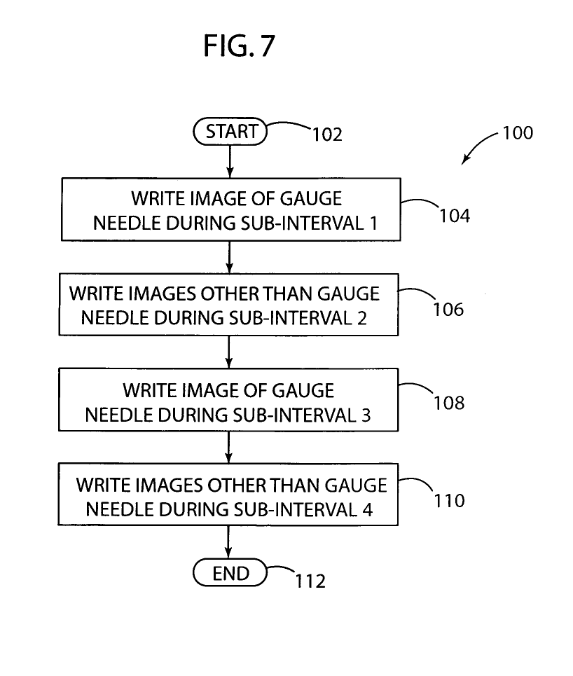

With respect to FIGS. 1, 2, and 7, a method of displaying an image is generally shown in FIG. 7 at 100. The method 100 starts at step 102, and proceeds to step 104, wherein an image of the gauge needle is written during sub-interval 1. At step 106, images other than the gauge needle are written during sub-interval 2. The method 100 then proceeds to step 108. At step 108, an image of the gauge needle is written during sub-interval 3. Typically, steps 104 and 108 are substantially similar, but are performed during two different sub-intervals of the frame interval (e.g., sub-intervals 1 and 3). At step 110, images other than the gauge needle are written during sub-interval 4, and the method 100 then ends at step 112.

According to one embodiment, the display device 12 is a PMOLED display that displays or presents an image that appears to be smoothly moving (e.g., the gauge needle portion of the display is updated at a first rate, such as, but not limited to, one hundred twenty (120) times per second), while the remainder of the display is updated at a second lower rate, such that the display does not appear to flicker to the human eye (e.g., updated sixty (60) times per second). Thus, the number of updates during a frame interval is reduced relative to updating the entire display at the higher rate. This can result in reducing the operating power of the display system 10, and allows for more pixels to be addressed, such that a user can view the display device 12 having a suitable resolution. Also, the display system 10 can have a reduced cost when the display device 12 is a PMOLED, as compared to when the display device 12 is an AMOLED or an AMLCD display. Additionally, because the entire image is not updated at the higher rate (e.g., one hundred twenty (120) times per second), the computational capability (e.g., display controller 14) of the display system 10 and required memory bandwidth can be reduced when compared to a system that updates the entire image at the higher rate.

When sweeping a graphical pointer on a pixelated display, the human eye perceives stepping in the movement if pixels are skipped by the tip of the pointer, according to one embodiment. Thus, pixels not utilized in the sweep of the point can be perceived by the eye when the movement rate of the graphical pointer is such that by the next display frame, the pointer has moved enough that pixels are skipped out at the tip of the pointer. Display frame rate limits how smooth a pointer sweep can be perceived. A one hundred twenty Hertz (120) Hz display could conceivably show a longer pointer being swept assuming the graphical processing could update the image at that rate. Similarly, a thirty Hertz (30) Hz display may be able to smoothly sweep the longer pointer at one-quarter the rate of the one hundred twenty Hertz (120) Hz frame rate display.

Stepping in the display of a pointer sweep can become unavoidable once the movement rate in degrees per second exceeds the rate where the tip of the pointer moves through every pixel at the display frame rate, according to one embodiment. Depending on the actual display technology, smooth moving pointers may be achieved by utilizing stepping if the movement rate is ramped into and out of the speed at which stepping is unavoidable.

Advantageously, the display system 10 and method 100 can display images, wherein a portion of the image is updated at a higher rate than other portions of the image, which can reduce the computational capability needed within the system 10. Additionally, the display system 10 and method 100 can result in better human-machine interface, faster development time, the ability to customize the display in a vehicle for the user's needs, the ability to display video (e.g., from a back-up camera), have a fast turn-on time in cold ambient temperatures, and improved contrast ratio in a situation with lower ambient light. Additionally or alternatively, the display system 10 can include at least one input device, such that the displayed images, colors of images, the like, or a combination thereof can be selected by a user of the system 10. It should be appreciated by those skilled in the art that the display system 10 and method 100 can include additional or alternative advantages. It should further be appreciated by those skilled in the art that the above components and steps can be configured in additional or alternative ways.

The above description is considered that of preferred embodiments only. Modifications of the invention will occur to those skilled in the art and to those who make or use the invention. Therefore, it is understood that the embodiments shown in the drawings and described above are merely for illustrative purposes and not intended to limit the scope of the invention, which is defined by the following claims as interpreted according to the principles of patent law, including the doctrine of equivalents.

1. A display system comprising:
a display device configured to produce a display comprising:
a first portion; and
a second portion; and
a controller in communication with said display device, wherein said controller updates said first portion of said display at a higher rate than said second portion of said display device.

2. The display system of claim 1, wherein said higher rate of updating said first portion is approximately twice a rate of updating said second portion.

3. The display system of claim 1, wherein said first portion of said display device produces an image of a moving element a plurality of times during a frame interval.

4. The display system of claim 1, wherein said first portion is updated at approximately one hundred twenty (120) times per second.

5. The display system of claim 1, wherein said second portion is updated at approximately sixty (60) times per second.

6. The display system of claim 1, wherein said display device is a passive matrix organic light emitting diode (PMOLED) display.

7. The display system of claim 1, wherein said display device is an active matrix organic light emitting diode (AMOLED) display.

8. The display system of claim 1, wherein the display system is used with a vehicle.

9. The display system of claim 8, wherein the display system is used in an instrument panel of said vehicle.

10. The display system of claim 1, wherein said first portion is updated at said higher rate than said second portion, which allows a human eye to perceive movement of an imaged component on the display.

11. The display system of claim 1, wherein said second portion is updated at a lower rate than said first portion, which allows a human eye to not perceive flickering of the display.

12. A display system comprising:
a passive matrix organic light emitting diode (PMOLED) display device configured to produce a display, wherein said PMOLED display device comprises:
a first portion; and
a second portion; and
a controller in communication with said PMOLED display device, wherein said controller updates said first portion of said PMOLED display device, wherein said controller updates said first portion of said PMOLED display device at approximately one hundred twenty (120) times per second, and said controller updates said second portion of said PMOLED display device at approximately sixty (60) times per second.

13. The display system of claim 12, wherein the first portion of said PMOLED display device produces an image of a moving element.

14. The display system of claim 12, wherein the display system is used in an instrument panel of a vehicle.

15. A method of displaying an image, said method comprising the steps of:
providing a frame interval, wherein substantially all pixels of a display device are updated during said frame interval;
updating a first portion of said display device during a first sub-interval of said frame interval;
updating a second portion of said display device during a second sub-interval of said frame interval;
updating said first portion of said display device during a third sub-interval of said frame interval; and
updating a third portion of said display device during a fourth sub-interval of said frame interval.

16. The method of claim 15, wherein said frame interval is approximately one-sixtieth of a second.

17. The method of claim 15, wherein said display device is a passive matrix organic light emitting diode (PMOLED) display.

18. The method of claim 15, wherein said display is an active matrix organic light emitting diode (AMOLED) display.

19. The method of claim 15, wherein the method is used with a vehicle.

20. The method of claim 15, wherein said sub-intervals are of approximately equal time length, such that said first portion of said display device is updated at approximately twice the rate of said second portion of said display device.
